(19) United States
(12) Patent Application Publication
(10) Pub. No.: US 2025/0124490 A1
(43) Pub. Date: Apr. 17, 2025

(54) Electronic Devices and Corresponding Methods for Presenting Notification Data Structures as a Function of User Data Structures

(71) Applicant: Motorola Mobility LLC, Chicago, IL (US)

(72) Inventors: Amit Kumar Agrawal, Banaglore (IN); Krishnan Raghavan, Bangalore (IN); Hariprasad Shanbhogue Alampady, Bangalore (IN)

(21) Appl. No.: 18/379,591

(22) Filed: Oct. 12, 2023

(51) Int. Cl. G06Q 30/0601; G06Q 20/40; G06Q 30/0207

(52) U.S. Cl. CPC G06Q 30/0641; G06Q 20/405; G06Q 30/0222; G06Q 30/0631

(57) ABSTRACT

A method in an electronic device detects, by one or more processors from user input received by a user interface of the electronic device, shopping cart interaction events to an electronic shopping cart within an electronic shopping interactive computing environment. The one or more processors map attempts within the electronic shopping interactive computing environment to meet one or more promotional data structures based upon minimum purchase quantities and/or minimum purchase amounts and cause the user interface to present one or more product notification data structures meeting the one or more promotional data structures as a function of a user persona and behavior data structure retrieved from memory.

### BACKGROUND

### Technical Field

This disclosure relates generally to electronic devices, and more particularly to electronic devices having user interfaces.

### Background Art

Portable electronic devices, such as smartphones and tablet computers, are now the primary electronic tools with which people communicate, engage in commerce, maintain calendars and itineraries, monitor health, capture images and video, and surf the Internet. In many instances, a person is more likely to carry a smartphone than a watch or wallet. Indeed, with the advent of personal finance, banking, and shopping applications many people can transact personal business solely using a smartphone and without the need for cash or a physical credit card. When used in conjunction with e-commerce sites, such devices make it incredibly simple to purchase goods and services with just a click or two.

While such technology is incredibly convenient, the ease with which modern electronic devices can engage in electronic commerce transactions can cause unintended issues for a user. It would be advantageous to have improved devices and systems to address such unintended issues.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present disclosure.

FIG. 1 illustrates one or more method steps in accordance with one or more embodiments of the disclosure.

FIG. 2 illustrates one explanatory electronic device in accordance with one or more embodiments of the disclosure.

FIG. 3 illustrates one explanatory method in accordance with one or more embodiments of the disclosure.

FIG. 4 illustrates another explanatory method in accordance with one or more embodiments of the disclosure.

FIG. 5 illustrates one or more method steps in accordance with one or more embodiments of the disclosure.

FIG. 6 illustrates various embodiments of the disclosure.

FIG. 7 illustrates a prior art method.

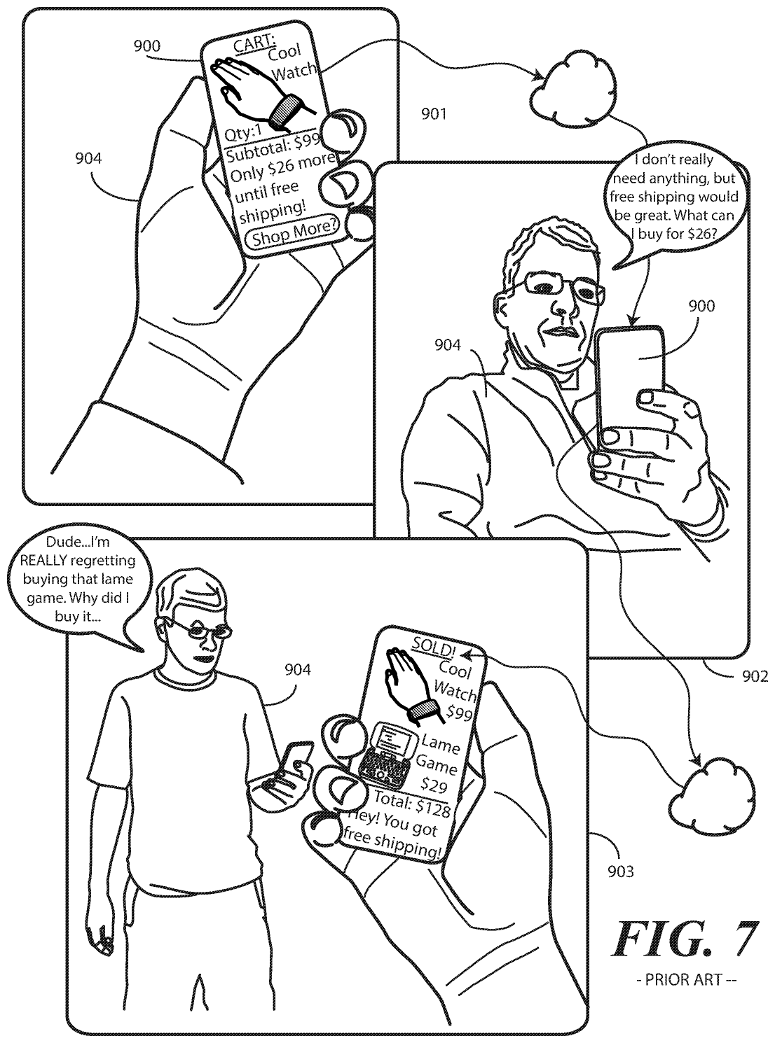

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

### DETAILED DESCRIPTION OF THE DRAWINGS

Before describing in detail embodiments that are in accordance with the present disclosure, it should be observed that the embodiments reside primarily in combinations of method steps and apparatus components related to detecting user input at a user interface defining one or more shopping cart interaction events within an electronic shopping interactive computing environment, mapping attempts within the electronic shopping interactive computing environment to meet one or more promotional data structures and/or minimum purchase amounts, and causing, by one or more processors, the user interface to present one or more product notification data structures meeting the one or more promotional data structures and/or minimum purchase amounts as a function of a user persona and behavior data structure retrieved from a memory of the electronic device. Any process descriptions or blocks in flow charts should be understood as representing modules, segments, or portions of code which include one or more executable instructions for implementing specific logical functions or steps in the process.

Alternate implementations are included, and it will be clear that functions may be executed out of order from that shown or discussed, including substantially concurrently or in reverse order, depending on the functionality involved. Accordingly, the apparatus components and method steps have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

Embodiments of the disclosure do not recite the implementation of any commonplace business method aimed at processing business information, nor do they apply a known business process to the particular technological environment of the Internet. Moreover, embodiments of the disclosure do not create or alter contractual relations using generic computer functions and conventional network operations. Quite to the contrary, embodiments of the disclosure employ methods that, when applied to electronic device and/or user interface technology, improve the functioning of the electronic device itself by and improving the overall user experience to overcome problems specifically arising in the realm of the technology associated with electronic device user interaction.

It will be appreciated that embodiments of the disclosure described herein may be comprised of one or more conventional processors and unique stored program instructions that control the one or more processors to implement, in conjunction with certain non-processor circuits, some, most, or all of the functions of, in response to user input received at a user interface of an electronic device causing one or more shopping cart interaction events to an electronic shopping cart in an electronic shopping application operating on one or more processors of the electronic device, the presentation of at least one offer meeting one or more promotional data structures based upon minimum purchase quantities or minimum purchase amounts exceeding one or more present purchase quantities or present purchase amounts defined by the one or more shopping cart interaction events to the electronic shopping cart as described herein. The non-processor circuits may include, but are not limited to, a radio receiver, a radio transmitter, signal drivers, clock circuits, power source circuits, and user input devices. As such, these functions may be interpreted as steps of a method to perform the detection of shopping cart interaction events to an electronic shopping cart within an electronic shopping interactive computing environment operating on one or more processors and causing, by the one or more processors, a user interface to present indicia offering at least one additional shopping cart addition that facilitate achievement of the one or more promotional data structures of the electronic shopping interactive computing environment based upon minimum purchase quantities or minimum purchase amounts from a map defined in a memory of the electronic device.

Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

Embodiments of the disclosure are now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Relational terms such as first and second, top and bottom, and the like may be used solely to distinguish one entity or action from another entity or action without necessarily requiring or implying any actual such relationship or order between such entities or actions.

As used herein, components may be “operatively coupled” when information can be sent between such components, even though there may be one or more intermediate or intervening components between, or along the connection path. The terms “substantially,” “essentially,” “approximately,” “about,” or any other version thereof, are defined as being close to as understood by one of ordinary skill in the art, and in one non-limiting embodiment the term is defined to be within ten percent, in another embodiment within five percent, in another embodiment within one percent and in another embodiment within one-half percent. The term “coupled” as used herein is defined as connected, although not necessarily directly and not necessarily mechanically. Also, reference designators shown herein in parenthesis indicate components shown in a figure other than the one in discussion. For example, talking about a device (10) while discussing figure A would refer to an element, 10, shown in figure other than figure A.

In one or more embodiments, a method in an electronic device comprises, in response to initiation of an electronic shopping interactive computing environment operating on one or more processors of the electronic device, retrieving, by the one or more processors from a memory of the electronic device, a user persona and behavior data structure defining one or more past purchase patterns occurring in the electronic shopping interactive computing environment or another electronic shopping interactive computing environment. In one or more embodiments, the method comprises detecting, by the one or more processors from user input received by a user interface of the electronic device, shopping cart interaction events to an electronic shopping cart within the electronic shopping interactive computing environment.

In one or more embodiments, the one or more processors map attempts within the electronic shopping interactive computing environment to meet one or more promotional data structures based upon minimum purchase quantities and/or minimum purchase amounts. In one or more embodiments, the one or more processors then cause the user interface to present one or more product notification data structures meeting the one or more promotional data structures as a function of the user persona and behavior data structure.

Advantageously, this method ensures that optimized user interaction events in the electronic shopping interactive computing environment occur, thereby preventing spurious or superfluous user interaction events that attempt to meet the minimum purchase quantities or minimum purchase amounts, and that result in cognitive dissonance in a user thereafter. Advantageously, the product notification data structures meeting the minimum purchase quantities or minimum purchase amounts that are presented on the user interface save the user of the electronic device both time and user interaction events searching through the electronic shopping interactive computing environment to find electronic shopping interactive computing environment offers fulfilling the minimum purchase quantities or minimum purchase amounts.

Embodiments of the disclosure can create, using one or more processors in a memory of an electronic device, the user persona and behavior data structure itself. In one or more embodiments, the user persona and behavior data structure defines one or more consumption patterns based upon frequencies of past purchases made, categories of past purchases made, consumption trends of past purchases made, quantities of past purchases made, expiration dates of past purchases made, or combinations thereof. When the one or more processors detect, from a user interface of the electronic device, shopping cart interaction events to an electronic shopping cart within an electronic shopping interactive computing environment operating on the one or more processors, the one or more processors can map in the memory a total shopping cart value of the shopping cart interaction events, one or more promotional data structures of the electronic shopping interactive computing environment based upon minimum purchase quantities and/or minimum purchase amounts, and data from the user persona and behavior data structure.

The one or more processors can then cause the user interface to present indicia offering at least one additional shopping cart addition to facilitate achievement of the one or more processors promotional data structures of the electronic shopping interactive computing environment based upon the minimum purchase quantities or the minimum purchase amounts. When user interface in the electronic shopping interactive computing environment oscillates, the one or more processors can detect this. Thereafter, if the oscillation of the shopping cart interaction events results in at least one shopping cart addition being unavailable to prevent the achievement of the one or more promotional data structures of the electronic shopping interactive computing environment based upon the minimum purchase quantities or the minimum purchase amounts, the one or more processors can cause the user interface to present other indicia offering at least one additional shopping cart addition related to the at least one shopping cart addition.

Embodiments of the disclosure contemplate that electronic shopping interactive computing environments with which portable electronic devices can seamlessly and quickly interact are proliferating rapidly. Illustrating by example, “Hello Shopping” is a new electronic shopping interactive computing environment available from Motorola Mobility.sup.™ that allows remote electronic devices to make user interaction events allowing their users to engage in electronic transaction events to contract for purchase various items, examples of which include fashion, appliances, home décor, and books. Hello Shopping is one of the first electronic shopping interactive computing environments to be natively integrated into smartphones and other electronic devices manufactured by Motorola Mobility.sup.™. This electronic shopping interactive computing environment supports core missions of being a secure electronic shopping interactive computing environment that allows user interaction events to transact for items of quality from credible sources.

While discounts can drive the volume of user interaction events in such electronic shopping interactive computing environments, they can also harm user's perceptions of an electronic shopping interactive computing environment. When vendors operating in an electronic shopping interactive computing environment or the purveyors of the electronic shopping interactive computing environment attempt to drive user interaction events with minimum purchase quantities or minimum purchase amounts, this can result in users regretting their user interaction events. In some cases, it can result in users discontinuing engagement with the electronic shopping interactive computing environment.

Advantageously, embodiments of the disclosure cause the presentation of one or more product notification data structures meeting one or more promotional data structures as a function of a user persona and behavior data structure stored in a memory of the electronic device. This results in users experiencing more satisfactory user interaction events without cognitive dissonance thereafter. This provides a win-win situation for both vendors operating in an electronic shopping interactive computing environment and users of the electronic shopping interactive computing environment.

To illustrate how less than desirable user interaction events in an electronic shopping interactive computing environment can frustrate a user, turn now to FIG. 9. Illustrated in FIG. 9 is a prior art method.

Beginning at step 901, a user 904 is interacting with an electronic shopping interactive computing environment using a smartphone 900. Delivering user interaction events to the user interface of the smartphone 900, the user 904 has transacted to purchase a really cool watch. However, the electronic shopping interactive computing environment offers a minimum purchase amount that will allow the really cool watch to ship from the vendor free of charge. If the user 904 provides additional user interaction events causing the total value of the electronic shopping cart to exceed one hundred and twenty-five dollars, shipping will indeed be free.

At step 902, the user 904 wonders what he might need for twenty-six dollars. Really desiring the free shipping, the user 904 hunts through the electronic shopping interactive computing environment to find something for that amount. Delivering successive user interaction events to the electronic shopping interactive computing environment, the user ends up transacting for an additional purchase.

As shown at step 903, the user interaction events delivered at step 902 resulted in the user 904 transacting to buy a really lame game. Cognitive dissonance sets in as the user 904 did not want the really lame game but felt compelled to purchase it to obtain the free shipping. The user is now mad not only at the really lame game, but also at the electronic shopping interactive computing environment and the purveyor of the same.

Embodiments of the disclosure provide a solution that prevents this madness by creating, in one or more embodiments, a user persona and behavior data structure in a memory of an electronic device. in one or more embodiments, the user persona and behavior data structure defines one or more consumption patterns based upon frequencies of past purchases made, categories of past purchases made, consumption trends of past purchases made, quantities of past purchases made, expiration dates of past purchases made, and combinations thereof.

When the one or more processors of the electronic device detect, at a user interface of the electronic device, shopping cart interaction events to an electronic shopping cart within an electronic shopping interactive computing environment operating on the one or more processors, the one or more processors can define a map of a total shopping cart value for the shopping cart interaction events, one or more promotional data structures of the electronic shopping interactive computing environment based upon minimum purchase quantities and/or minimum purchase amounts, and data from the user persona and behavior data structure. The one or more processors can then cause the user interface to present indicia offering at least one additional shopping cart addition that facilitate achievement of the one or more promotional data structures of the electronic shopping interactive computing environment based upon the minimum purchase quantities and/or the minimum purchase amounts. Advantageously, this avoids the cognitive dissonance the user 904 experiences at step 903 of FIG. 9.

To illustrate how this works, turn now to FIG. 9 where our dear user 904 is now equipped with an electronic device 100 configured in accordance with one or more embodiments of the disclosure. Beginning at step 101, one or more processors of the electronic device 100 create, in a memory of the electronic device 100, a user persona and behavior data structure 109 defining one or more consumption patterns of the user 904.

In one or more embodiments, the user persona and behavior data structure 109 is created from a set of patterns derived from past purchase trends. Such trends can include the frequency of purchases made, the category of products purchased, e.g., apparel, appliances, electronics, groceries, household essentials, and so forth, consumption trends, such as for groceries and household essentials, the size of the family of the user, e.g., how many vegetables or groceries the family consumes in a given period of time, and other factors. The user persona and behavior data structure 109 can also consider the expiration dates of goods purchased using the electronic shopping interactive computing environment as well. In one or more embodiments, the user persona and behavior data structure 109 defines one or more consumption patterns based upon the frequencies of past purchases made using the electronic shopping interactive computing environment, the categories of past purchases made using the electronic shopping interactive computing environment, the consumption trends of the past purchases made using the electronic shopping interactive computing environment, the quantities of past purchases made using the electronic shopping interactive computing environment, the expiration dates of the past purchases made using the electronic shopping interactive computing environment, and combinations thereof.

At step 102, one or more processors of the electronic device 100 have detected, from user input 110 received by a user interface 111 of the electronic device 100, one or more shopping cart interaction events 112 to an electronic shopping cart 113 of an electronic shopping interactive computing environment 114 operating on one or more processors of the electronic device 100. In this illustrative example, the one or more shopping cart interaction events 112 have added the really cool watch to the electronic shopping cart 113 of the electronic shopping interactive computing environment 114.

As before, the electronic shopping interactive computing environment 114 offers one or more minimum purchase quantities and/or minimum purchase amounts 115 to incentivize the user 904. In thus illustrative embodiment, the one or more minimum purchase quantities and/or minimum purchase amounts 115 comprise a minimum purchase amount indicating that if a total shopping cart value 116 of the shopping cart interaction events 112 exceeds one hundred and twenty-five dollars, a free shipping discount will be applied to the electronic shopping cart 113.

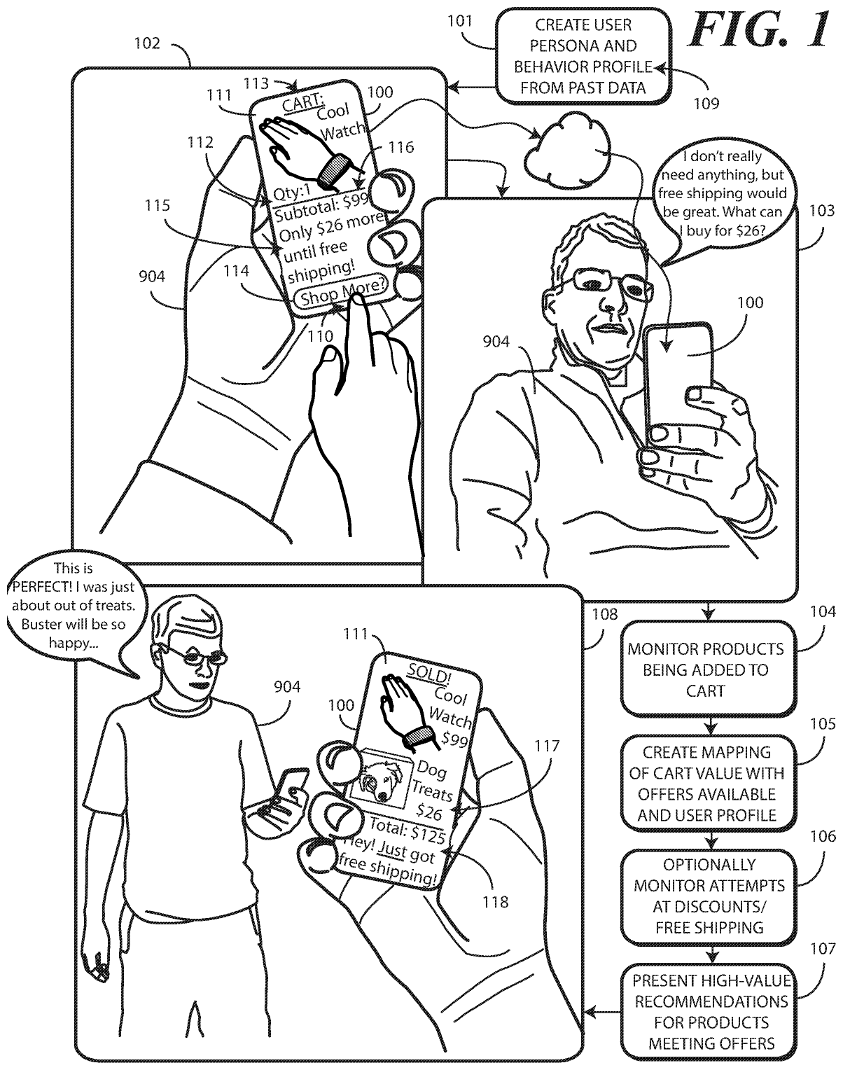

At step 103, the user 904 wonders what he might need for twenty-six dollars. Recall from above that in the prior art method of FIG. 9 the user had to hunt through the electronic shopping interactive computing environment 114 to find something for that amount. Such is not the case in FIG. 1.

Instead, the one or more processors of the electronic device 100 will create a mapping of the current cart value, offer values available for a minimum purchase amount and cart value, and the user persona and behavior data structure 109 based on past purchase trends. The one or more processors can optionally determine if the user 904 is juggling to add and/or remove items from the electronic shopping cart 113 that causes the total shopping cart value 116 to approach the minimum purchase amount as being an indication that the user 904 is intending to avail himself of the promotional offer.

From this mapping, the one or more processors can provide the user 904 with a high customer value recommendation for adding products to the electronic shopping cart 113 that meet the offer in an optimal way. Illustrating by example, when the total shopping cart value 116 is closer to an offer that is available, indicia offering at least one additional shopping cart addition that will be useful to the user 904, e.g., consumable grocery items or house cleaning items. In one or more embodiments, the additional shopping cart addition has a delayed expiration date, meaning that it will be good for some period of time after the exchange in the electronic shopping interactive computing environment 114 is completed. In one or more embodiments, the additional shopping cart addition can suggest alternative products to those that the user 904 has added to the electronic shopping cart 113 based upon a determination that those products in the electronic shopping cart 113 will not be consumed prior to their expiration date.

For instance, the additional shopping cart addition may suggest a non-perishable item available in the electronic shopping interactive computing environment 114 that does not expire. Examples include bathroom cleaners and soaps. In other embodiments, the additional shopping cart addition may be for a product that the user 904 purchased a long time ago since such an item is more likely to have already been consumed.

In still other embodiments, the additional shopping cart addition can suggest a “right priced” product that takes the user 904 above the required value to achieve the minimum purchase amount, but not too high above the minimum purchase amount. For instance, if the user were at one hundred and twenty-two dollars, and the minimum purchase amount was one hundred and twenty-five dollars, technically the user 904 would only need to add an item having a three-dollar value to the electronic shopping cart 113 to receive the promotional discount. However, some prior art systems can suggest products far in excess of this value which, if selected, would make the promotional discount less financially rewarding for the user 904 as a percentage of the total shopping cart value 116. Accordingly, in one or more embodiments the additional shopping cart addition is suggested with a value that is substantially similar to the difference between the minimum purchase amount and the current total shopping cart value 116.

Embodiments of the disclosure contemplate that when the total shopping cart value 116 is one hundred and twenty-two dollars, and the minimum purchase amount was one hundred and twenty-five dollars, a user may add something for five dollars, then remove something else that costs two dollars to hit the minimum purchase amount perfectly. These user interaction events are referred to as “toggling” or “oscillation of the shopping cart interaction events to the electronic shopping cart.” In some cases, when the user 904 finally gets the overall user interaction events correct at least one item in the electronic shopping cart 113 will now be out of stock. When this occurs, the user 904 will have to backtrack through the user interaction events or start over to try and figure out which products were removed from the electronic shopping cart 113 so that they can be added back. In one or more embodiments, the additional shopping cart addition therefore constitutes a “recently removed product” when oscillation of the shopping cart interaction events 112 to the electronic shopping cart 113 attempting to meet one or more promotional discounts so that the user 904 can execute a user interaction event to quickly add that recently removed product back to the electronic shopping cart 113.

Advantageously, embodiments of the disclosure ensure that the user 904 is able to purchase relevant goods that are needed, rather than goods that they would not have purchased unless chasing a promotional discount. This prevents the user 904 from wasting money on unwanted purchases. Moreover, it frees the user 904 from any “quick, act now” time pressures that may make him make a quick decision that later leads to cognitive dissonance. Embodiments of the disclosure advantageously prevent upselling that leads to user frustration and prevent the regret that a user 904 may have when purchasing redundant goods.

What's more, embodiments of the disclosure help to protect brand protection of not only the goods purchased, but also of the electronic shopping interactive computing environment 114 as well. When many different discounts are thrown at customers this can cause them to devalue brand equity. It can also train customers to expect a discount. Embodiments of the disclosure avoid these issues by using discounts strategically.

Embodiments of the disclosure also advantageously help to maximize profitability of the electronic shopping interactive computing environment 114. Embodiments of the disclosure contemplate that purveyors of electronic shopping interactive computing environments who use psychological tactics without considering margins may reduce profitability so much that it does not make sense to offer them in the first place. Embodiments of the disclosure help to protect margins by again using discount data structures strategically. Advantageously, embodiments of the disclosure facilitate the offer of specific promotions to specific customers based upon their specific intent. Using embodiments of the disclosure, manufacturers and purveyors of electronic shopping interactive computing environments can deliver promotional data structures to customers on the fence about making a purchase rather than to all users interacting with the electronic shopping interactive computing environment. This ensures that such manufacturers and purveyors of electronic shopping interactive computing environments will not lose out on customers who would have happily paid full price. Embodiments of the disclosure also do not provide discounts to users who have no intention to purchase, thereby risking brand value degradation and price sensitivity.

Returning to the method steps of FIG. 1, at step 104, the one or more processors of the electronic device 100 detect, from user input 110 received by the user interface 111 of the electronic device 100, shopping cart interaction events 112 to the electronic shopping cart 113 within the electronic shopping interactive computing environment 114. At step 105, in response, the one or more processors of the electronic device 100 retrieve the user persona and behavior data structure 109 from a memory of the electronic device 100. In one or more embodiments, the user persona and behavior data structure 109 defines one or more past purchase patterns occurring in the electronic shopping interactive computing environment 114 or another electronic shopping interactive computing environment.

At step 105, in one or more embodiments the one or more processors define a map of the total shopping cart value 116 of the shopping cart interaction events 112, one or more promotional data structures of the electronic shopping interactive computing environment 114 based upon minimum purchase quantities and/or minimum purchase amounts 115, and data from the user persona and behavior data structure 109.

At optional step 106, the one or more processors of the electronic device 100 detect user input causing oscillation of the shopping cart interaction events 112 in the electronic shopping cart 113 attempting to meet the one or more promotional data structures based upon the minimum purchase quantities and/or minimum purchase amounts 115. Examples of this were described above. If, for example, the user 904 executed user interaction events causing seven four-dollar items to be added to the electronic shopping cart 113, and then removed one only to add another one-dollar item thereafter, this would constitute an oscillation of the shopping cart interaction events 112 in the electronic shopping cart 113 attempting to meet the one or more promotional data structures based upon the minimum purchase quantities and/or minimum purchase amounts 115.

At step 107, the one or more processors of the electronic device 100 cause the user interface 111 to present indicia offering at least one additional shopping cart addition that facilitates achievement of the one or more promotional data structures of the electronic shopping interactive computing environment 114 based upon the minimum purchase quantities and/or minimum purchase amounts 115. One example of such an additional shopping cart addition 117 is shown at step 108.

In this illustrative example, the additional shopping cart addition 117 is a suggested box of dog treats for the user's dog, Buster. The additional shopping cart addition was selected based upon the price needed to achieve the promotional data structure, namely, twenty-six dollars, combined with the quantities and expiration dates of the past purchases made found in the user persona and behavior data structure 109. Here, the one or more processors of the electronic device 100 determined that the user last purchased dog treats some time ago. Given that Buster is an exceptionally great dog, the one or more processors surmised that the treats may now be running low in quantity. Accordingly, the additional shopping cart addition 117 comprises another box of treats that hits the promotional data structure 118 perfectly, thereby allowing the user 904 to receive free shipping.

As noted above, if the oscillation of the shopping cart interaction events detected at step 106 results in at least one shopping cart addition being unavailable to prevent the achievement of the one or more promotional data structures 118 of the electronic shopping interactive computing environment 114 based upon the minimum purchase quantities and/or minimum purchase amounts 115, step 107 can comprise causing, by the one or more processors, the user interface 111 to present other indicia offering at least one other additional shopping cart addition related to the at least one additional shopping cart addition. Thus, if the if the oscillation of the shopping cart interaction events detected at step 106 placed dog food in the electronic shopping cart 113, but the dog food selected was out of stock, the additional shopping cart addition 117 may be another brand of dog food with similar ingredients and nutritional structure since that is related to the dog food selected by the user.

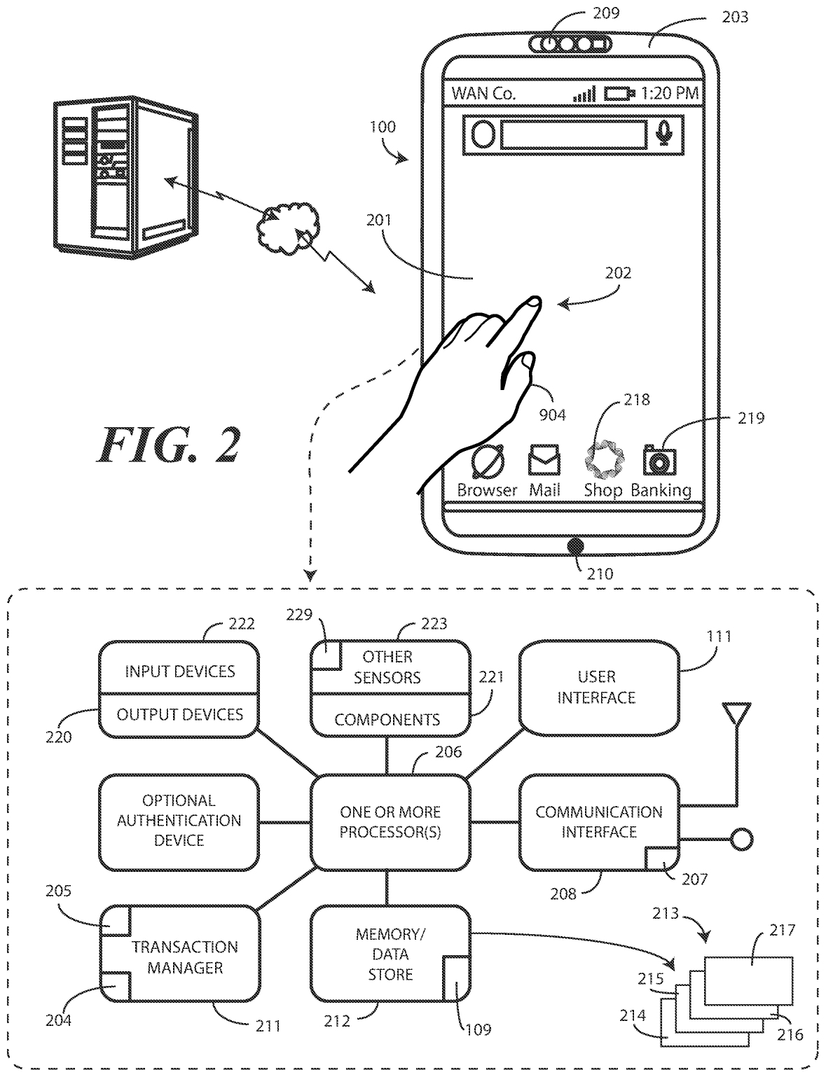

Turning now to FIG. 2, illustrated therein is one electronic device 100 configured in accordance with one or more embodiments of the disclosure. The electronic device 100 of this illustrative embodiment includes a user interface 111. In one or more embodiments, the user interface 111 comprises a display 201, which may optionally be touch-sensitive. The display 201 can serve as a primary user interface 111 of the electronic device 100.

Where the display 201 is touch sensitive, users can deliver user input to the display 201 by delivering touch input from a finger, stylus, or other objects disposed proximately with the display. In one embodiment, the display 201 is configured as an active-matrix organic light emitting diode (AMOLED) display. However, it should be noted that other types of displays, including liquid crystal displays, would be obvious to those of ordinary skill in the art having the benefit of this disclosure.

The explanatory electronic device 100 of FIG. 2 includes a housing 203. Features can be incorporated into the housing 203. Examples of features that can be included along the housing 203 include an imager 209, shown as a camera in FIG. 2, or an optional speaker port. A user interface component 210, which may be a button or touch sensitive surface, can also be disposed along the housing 203.

A block diagram schematic of the electronic device 100 is also shown in FIG. 2. In one embodiment, the electronic device 100 includes one or more processors 206.

In one embodiment, the one or more processors 206 can include an application processor and, optionally, one or more auxiliary processors. One or both of the application processor or the auxiliary processor(s) can include one or more processors. One or both of the application processor or the auxiliary processor(s) can be a microprocessor, a group of processing components, one or more Application Specific Integrated Circuits (ASICs), programmable logic, or other type of processing device.

The application processor and the auxiliary processor(s) can be operable with the various components of the electronic device 100. Each of the application processor and the auxiliary processor(s) can be configured to process and execute executable software code to perform the various functions of the electronic device 100. A storage device, such as memory 212, can optionally store the executable software code used by the one or more processors 206 during operation. As notes above, the memory 212 can also store a user persona and behavior data structure 109 as well. The user persona and behavior data structure 109 can define one or more consumption patterns based upon frequencies of past purchases made, categories of past purchases made, consumption trends of past purchases made, quantities of past purchases made, expiration dates of past purchases made, or combinations thereof.

In this illustrative embodiment, the electronic device 100 also includes a communication device 208 that can be configured for wired or wireless communication with one or more other devices or networks. The networks can include a wide area network, a local area network, and/or personal area network. The communication device 208 may also utilize wireless technology for communication, such as, but are not limited to, peer-to-peer, or ad hoc communications such as HomeRF, Bluetooth and IEEE 802.11 based communication, or alternatively via other forms of wireless communication such as infrared technology. The communication device 208 can include wireless communication circuitry, one of a receiver, a transmitter, or transceiver, and one or more antennas.

The electronic device 100 can optionally include a near field communication circuit 207 used to exchange data, power, and electrical signals between the electronic device 100 and another electronic device. In one embodiment, the near field communication circuit 207 is operable with a wireless near field communication transceiver, which is a form of radio-frequency device configured to send and receive radio-frequency data to and from the companion electronic device or other near field communication objects. In one or more embodiments, the near field communication circuit 207 is operable with a banking application 219 to complete financial transactions, provided there are no merchant or payment processor system malfunctions.

Where included, the near field communication circuit 207 can have its own near field communication circuit controller in one or more embodiments to wirelessly communicate with companion electronic devices using various near field communication technologies and protocols. The near field communication circuit 207 can include—as an antenna—a communication coil that is configured for near-field communication at a particular communication frequency.

The term “near-field” as used herein refers generally to a distance of less than about a meter or so. The communication coil communicates by way of a magnetic field emanating from the communication coil when a current is applied to the coil. A communication oscillator applies a current waveform to the coil. The near field communication circuit controller may further modulate the resulting current to transmit and receive data, power, or other communication signals with companion electronic devices.

In one embodiment, the one or more processors 206 can be responsible for performing the primary functions of the electronic device 100. For example, in one embodiment the one or more processors 206 comprise one or more circuits operable to present presentation information, such as images, text, and video, on the display 201. The executable software code used by the one or more processors 206 can be configured as one or more modules 213 that are operable with the one or more processors 206. Such modules 213 can store instructions, control algorithms, and so forth.

In one embodiment, the one or more processors 206 are responsible for running the operating system environment 214. The operating system environment 214 can include a kernel, one or more drivers, and an application service layer 215, and an application layer 216. The operating system environment 214 can be configured as executable code operating on one or more processors or control circuits of the electronic device 100.

The application service layer 215 can be responsible for executing application service modules. The application service modules may support one or more applications 217 or “apps.” Examples of such applications 217 include a cellular telephone application for making voice telephone calls, a web browsing application configured to allow the user to view webpages on the display 201 of the electronic device 100, an electronic mail application configured to send and receive electronic mail, a photo application configured to organize, manage, and present photographs on the display 201 of the electronic device 100, and a camera application for capturing images with the imager 209. Collectively, these applications constitute an “application suite.”

In one or more embodiments, these applications comprise an electronic shopping application 218 and/or one or more banking applications 219 that allow financial transactions to be made using the electronic device 100. When launched, the electronic shopping application 218 can cause an electronic shopping interactive computing environment to be presented on the user interface 111 of the electronic device. A user 904 can perform user interaction events 202 in the electronic shopping interactive computing environment to transact electronic commerce.

Illustrating by example, in one or more embodiments a user can deliver user input to the electronic shopping application 218 cause shopping cart interaction events to occur in an electronic shopping cart within the electronic shopping interactive computing environment of the electronic shopping application 218. The user interaction events 202 can also cause oscillation of the shopping cart interaction events to the electronic shopping cart when the user 904 is attempting to meet one or more promotional data structures based upon minimum purchase quantities and/or minimum purchase amounts as previously described as well.

In one or more embodiments, a transaction manager 211 is operable with the one or more processors 206. In some embodiments, the one or more processors 206 can control the transaction manager 211. In other embodiments, the transaction manager 211 can operate independently, delivering information gleaned from detecting multi-modal social cues, emotional states, moods, and other contextual information to the one or more processors 206. The transaction manager 211 can receive data from the various sensors. In one or more embodiments, the one or more processors 206 are configured to perform the operations of the transaction manager 211.

In one or more embodiments, the transaction manager 211 can create a map 204 of attempts within the electronic shopping interactive computing environment to meet one or more promotional data structures based upon minimum purchase amounts and/or minimum purchase quantities. In one or more embodiments, the map 204 determines a value of all shopping cart interaction events to the electronic shopping cart of the electronic shopping interactive computing environment.

In one or more embodiments, the user persona and behavior data structure 109 can define a frequency of past purchases made using the electronic shopping interactive computing environment of the electronic shopping application 218 or another electronic shopping interactive computing environment. In one or more embodiments, the user persona and behavior data structure 109 defines categories of past purchases made using the electronic shopping interactive computing environment of the electronic shopping application 218 or another electronic shopping interactive computing environment.

In one or more embodiments, the user persona and behavior data structure 109 defines quantities of past purchases made using the electronic shopping interactive computing environment of the electronic shopping application 218 or another electronic shopping interactive computing environment. In one or more embodiments, the user persona and behavior data structure 109 defines one or more consumption trends associated with past purchases made using the electronic shopping interactive computing environment of the electronic shopping application 218 or another electronic shopping interactive computing environment. In one or more embodiments, the user persona and behavior data structure 109 defines one or more expiration dates for at least some of the past purchases made using the electronic shopping interactive computing environment of the electronic shopping application 218 or another electronic shopping interactive computing environment. Of course, these data can be used alone or in combination. Other data suitable for inclusion in the user persona and behavior data structure 109 will be obvious to those of ordinary skill in the art having the benefit of this disclosure.

In one or more embodiments, the transaction manager 211 or the one or more processors 206 create one or more product notification data structures 205. In one or more embodiments, the one or more product notification data structures 205 are configured to meet one or more promotional data structures as a function of the user persona and behavior data structure 109. The one or more processors 206 and/or transaction manager 211 can cause the user interface 111 to present the product notification data structures 205 in one or more embodiments.

Illustrating by example, in one or more embodiments, in response to user input received by the user interface 111 causing one or more shopping cart interaction events to an electronic shopping cart in the electronic shopping application 218 operating on the one or more processors 206, the one or more processors 206 cause the user interface 111 to present at least one notification offer meeting one or more promotional data structures based upon minimum purchase quantities or minimum purchase amounts exceeding present purchase quantities or present purchase amounts defined by the one or more shopping cart interaction events to the electronic shopping cart of the electronic shopping application 218. For example, when the one or more promotional data structures comprise a free shipping offer contingent upon a minimum electronic shopping cart total, the one or more processors 206 or transaction manager 211 can access the user persona and behavior data structure 109 recording past shopping cart interaction events made in the electronic shopping application 218. Thereafter, the at least one notification offer of the product notification data structures 205 can comprise at least one past shopping cart addition from the past shopping cart interaction events.

In other embodiments, the at least one offer of the product notification data structures 205 can optimize consumption of a combination of the past shopping cart interaction events and the one or more shopping cart interaction events prior to expiration dates of the past shopping cart interaction events and the one or more shopping cart interaction events as previously described. In still other embodiments, the product notification data structures 205 meeting one or more promotional data structures identify products predicted to be consumed prior to expiration based upon the one or more consumption trends associated with the past purchases made using the electronic shopping interactive computing environment of the electronic shopping application 218 or another electronic shopping interactive computing environment.

In one or more embodiments, the map 204 made by the transaction manager 211 detects user input causing oscillation of the shopping cart interaction events to the electronic shopping cart attempting to meet one or more promotional data structures based upon minimum purchase quantities and/or minimum purchase amounts. When the oscillation of the shopping cart interaction events results in consumable shopping cart interaction events predicted to be unconsumed prior to expiration based upon the one or more consumption trends associated with the past purchases made using the electronic shopping interactive computing environment of the electronic shopping application 218 or another electronic shopping interactive computing environment, at least one notification offer of the product notification data structures 205 can comprise a negative recommendation.

Illustrating by example, the negative recommendation can question whether the consumable shopping cart interaction events can be consumed prior to expiration. For instance, the negative recommendation may question whether the user 904 can really eat all of those pulses before they expire. The negative recommendation can also suggest at least one alternate shopping cart addition for the consumable shopping cart interaction events. If the user 904 has performed user interaction events 202 causing too many pulses to be added to the electronic shopping cart of the electronic shopping application 218, the negative recommendation may suggest dried beans with a longer shelf life instead.

In some embodiments, the negative recommendation of the product notification data structures 205 suggests at least one future promotional offer for the consumable shopping cart interaction events. Illustrating by example, if a user is adding toothpaste to the electronic shopping cart of the electronic shopping application 218 via the user interaction events 202, ant toothpaste will be on sale next week, the negative recommendation may say, “why don't you hold off on that toothpaste for a week since it will be 40% off next week and buy some nice dragonwell tea and jasmine pearls instead?” This is simply one example of a negative recommendation to be included with the product notification data structures 205. Others will be obvious to those of ordinary skill in the art having the benefit of this disclosure.

In one or more embodiments, the one or more processors 206 are responsible for managing the applications and all personal information received from the user interface 111 that is to be used by the electronic shopping application 218 and/or banking application 219 after the electronic device 100 is authenticated as a secure electronic device and the user identification credentials have triggered a login event. The one or more processors 206 can also be responsible for launching, monitoring, and killing the various applications and the various application service modules. In one or more embodiments, the one or more processors 206 are operable to not only kill the applications, but also to expunge any and all personal data, data, files, settings, or other configuration tools when the electronic device 100 is reported stolen to wipe the memory 212 clean of any personal data, preferences, or settings of the person previously using the electronic device 100.

The one or more processors 206 can also be operable with other components 221 and other sensors 223. The other components 221, in one embodiment, include input components 222, which can include acoustic detectors as one or more microphones. The one or more processors 206 may process information from the other components 221 alone or in combination with other data, such as the information stored in the memory 212 or information received from the user interface.

Various sensors 223 can be operable with the one or more processors 206 as well. A first example of a sensor that can be included with the sensors 223 is a touch sensor. The touch sensor can include a capacitive touch sensor, an infrared touch sensor, resistive touch sensors, or another touch-sensitive technology. Capacitive touch-sensitive devices include a plurality of capacitive sensors, e.g., electrodes, which are disposed along a substrate. Each capacitive sensor is configured, in conjunction with associated control circuitry, e.g., the one or more processors 206, to detect an object in close proximity with—or touching—the surface of the display 201 or the housing of an electronic device 100 by establishing electric field lines between pairs of capacitive sensors and then detecting perturbations of those field lines.

Another example of a sensor 223 is a geo-locator that serves as a location detector 229. In one embodiment, location detector 229 is able to determine location data by capturing the location data from a constellation of one or more earth orbiting satellites, or from a network of terrestrial base stations to determine an approximate location. Examples of satellite positioning systems suitable for use with embodiments of the present invention include, among others, the Navigation System with Time and Range (NAVSTAR) Global Positioning Systems (GPS) in the United States of America, the Global Orbiting Navigation System (GLONASS) in Russia, and other similar satellite positioning systems. The satellite positioning systems based location fixes of the location detector autonomously or with assistance from terrestrial base stations, for example those associated with a cellular communication network or other ground based network, or as part of a Differential Global Positioning System (DGPS), as is well known by those having ordinary skill in the art. The location detector 229 may also be able to determine location by locating or triangulating terrestrial base stations of a traditional cellular network, such as a CDMA network or GSM network, or from other local area networks, such as Wi-Fi networks.

One or more motion detectors can be included with the sensors 223 and can be configured as an orientation detector that determines an orientation and/or movement of the electronic device 100 in three-dimensional space. Illustrating by example, the motion detectors can include an accelerometer, gyroscopes, or other device to detect device orientation and/or motion of the electronic device 100. Using an accelerometer as an example, an accelerometer can be included to detect motion of the electronic device. Additionally, the accelerometer can be used to sense some of the gestures of the user, such as one talking with their hands, running, or walking.

The motion detectors can determine the spatial orientation and/or motion of the electronic device 100 in three-dimensional space by, for example, detecting a gravitational direction and acceleration due to applied forces. In addition to, or instead of, an accelerometer, an electronic compass can be included to detect the spatial orientation of the electronic device relative to the earth's magnetic field. Similarly, one or more gyroscopes can be included to detect rotational orientation of the electronic device 100.

A gaze detector can be included with the one or more sensors 223 and can comprise sensors for detecting the user's gaze point. The gaze detector can include an iris scanner. The gaze detector can optionally include sensors for detecting the alignment of a user's head in three-dimensional space. Electronic signals can then be processed for computing the direction of user's gaze in three-dimensional space. The gaze detector can further be configured to detect a gaze cone corresponding to the detected gaze direction, which is a field of view within which the user may easily see without diverting their eyes or head from the detected gaze direction. The gaze detector can be configured to alternately estimate gaze direction by inputting images representing a photograph of a selected area near or around the eyes. It will be clear to those of ordinary skill in the art having the benefit of this disclosure that these techniques are explanatory only, as other modes of detecting gaze direction can be substituted in the gaze detector.

Other components 221 operable with the one or more processors 206 can include output components 220 such as video, audio, and/or mechanical outputs. For example, the output components 220 may include a video output component or auxiliary devices including a cathode ray tube, liquid crystal display, plasma display, incandescent light, fluorescent light, front or rear projection display, and light emitting diode indicator. Other examples of output components 220 include audio output components such as a loudspeaker disposed behind a speaker port or other alarms and/or buzzers and/or a mechanical output component such as vibrating or motion-based mechanisms.

The other components 221 can also include proximity sensors. The proximity sensors fall in to one of two camps: active proximity sensors and “passive” proximity sensors. Either the proximity detector components or the proximity sensor components can be generally used for gesture control and other user interface protocols, some examples of which will be described in more detail below.

Proximity sensor components are sometimes referred to as a “passive IR detectors” due to the fact that the person is the active transmitter. Accordingly, the proximity sensor component requires no transmitter since objects disposed external to the housing deliver emissions that are received by the infrared receiver. As no transmitter is required, each proximity sensor component can operate at a very low power level. Simulations show that a group of infrared signal receivers can operate with a total current drain of just a few microamps.

By contrast, proximity detector components include a signal emitter and a corresponding signal receiver. While each proximity detector component can be any one of various types of proximity sensors, such as but not limited to, capacitive, magnetic, inductive, optical/photoelectric, imager, laser, acoustic/sonic, radar-based, Doppler-based, thermal, and radiation-based proximity sensors, in one or more embodiments the proximity detector components comprise infrared transmitters and receivers.

The other components 221 can optionally include a barometer operable to sense changes in air pressure due to elevation changes or differing pressures of the electronic device 100. Where included, in one embodiment the barometer includes a cantilevered mechanism made from a piezoelectric material and disposed within a chamber. The cantilevered mechanism functions as a pressure sensitive valve, bending as the pressure differential between the chamber and the environment changes. Deflection of the cantilever ceases when the pressure differential between the chamber and the environment is zero. As the cantilevered material is piezoelectric, deflection of the material can be measured with an electrical current.

The other components 221 can also optionally include a light sensor that detects changes in optical intensity, color, light, or shadow in the environment of an electronic device. This can be used to make inferences about context such as weather or colors, walls, fields, and so forth, or other cues. An infrared sensor can be used in conjunction with, or in place of, the light sensor. The infrared sensor can be configured to detect thermal emissions from an environment about the electronic device 100. Similarly, a temperature sensor can be configured to monitor temperature about an electronic device. The other components 221 can also include a flash. The other components 221 can also include a fingerprint sensor or retina scanner.

It is to be understood that FIG. 2 is provided for illustrative purposes only and for illustrating components of one electronic device 100 in accordance with embodiments of the disclosure and is not intended to be a complete schematic diagram of the various components required for an electronic device. Therefore, other electronic devices in accordance with embodiments of the disclosure may include various other components not shown in FIG. 2 or may include a combination of two or more components or a division of a particular component into two or more separate components, and still be within the scope of the present disclosure.

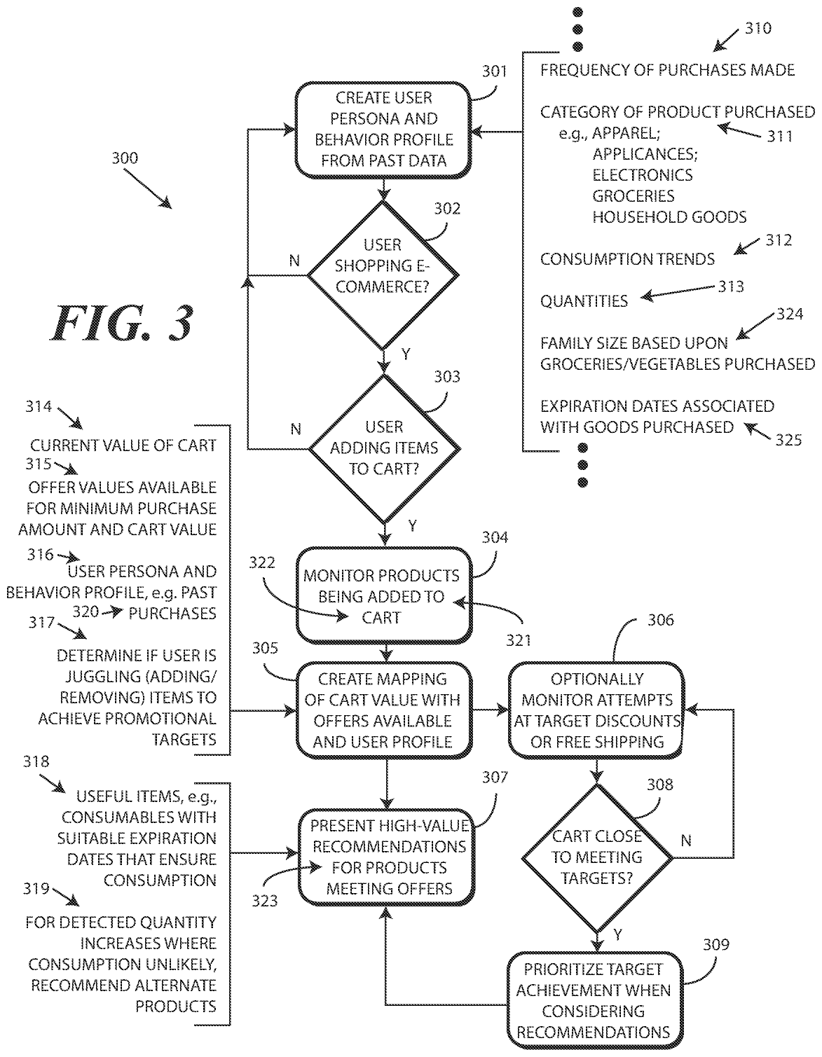

Turning now to FIG. 3, illustrated therein is one explanatory method 300 suitable for execution in an electronic device (100) in accordance with one or more embodiments of the disclosure. The method 300 of FIG. 3 retrieves a user persona and behavior data structure 316 from a memory that defines one or more past purchase patterns 320 occurring in an electronic shopping interactive computing environment or another electronic shopping interactive computing environment. The method 300 detects shopping cart interaction events 321 to an electronic shopping cart 322 with the electronic shopping interactive computing environment.

The method 300 maps attempts within the electronic shopping interactive computing environment to meet one or more promotional data structures 315 based upon minimum purchase quantities and/or minimum purchase amounts. The method 300 then causes the user interface of an electronic device to present one or more product notification data structures 323 meeting the one or more promotional data structures 315 as a function of the user persona and behavior data structure 316.

Beginning at step 301, the method 300 creates the user persona and behavior data structure 316 in a memory of an electronic device. In one or more embodiments, the user persona and behavior data structure 316 defines one or more consumption patterns based upon frequencies 310 of past purchases made, categories of past purchases made 311, consumption trends 312 of past purchases made, quantities 313 of past purchases made, expiration dates 325 of past purchases made, or combinations made. Other data can be included in the user persona and behavior data structure 316 as well, such as family size or consumption rate 324. Other data suitable for inclusion in the user persona and behavior data structure 316 will be obvious to those of ordinary skill in the art having the benefit of this disclosure.

At decision 302, the method determines whether an electronic shopping interactive computing environment operating on one or more processors of an electronic device has been initiated. Where it has, the method 300 moves to decision 303. Otherwise, the method 300 returns to step 301.

At decision 303, the method 300 detects shopping cart interaction events 321 to an electronic shopping cart 322 within the electronic shopping interactive computing environment. Where such shopping cart interaction events 321 are adding items to the electronic shopping cart 322 of the electronic shopping interactive computing environment, the method 300 moves to decision 304 where the items being added to the electronic shopping cart 322 of the electronic shopping interactive computing environment in response to the shopping cart interaction events 321 are monitored. Otherwise, the method 300 returns to step 301.

At step 305, the method 300 creates a mapping of attempts within the ese to meet one or more promotional data structures 315 based upon minimum purchase quantities and/or minimum purchase amounts. In one or more embodiments, step 305 creates a map of a total shopping cart value 314 of the shopping cart interaction events 321, one or more promotional data structures 315 of the electronic shopping interactive computing environment based upon minimum purchase quantities and/or minimum purchase amounts, and data from the user persona and behavior data structure 316.

Optional step 306 can detect oscillation 317 of the shopping cart interaction events 321 to the electronic shopping cart 322 attempting to meet the one or more promotional data structures 315 based upon the minimum purchase quantities and/or minimum purchase amounts as well, with decision 308 determining whether the total shopping cart value 314 is near the target set forth by the one or more promotional data structures 315. In one or more embodiments, these oscillations 317 of the shopping cart interaction events 321 result in consumable shopping cart interaction events predicted to be unconsumed prior to expiration based upon the one or more consumption trends 312 associated with the past purchases made using the electronic shopping interactive computing environment or another electronic shopping interactive computing environment. Accordingly, step 309 can prioritize target achievement when considering recommendations made in a product notification data structure 323.

At step 307, the method 300 presents one or more product notification data structures 323 meeting the one or more promotional data structures 315 as a function of the user persona and behavior data structure 316. The one or more product notification data structures 323 can comprise at least one notification offer 318 meeting the one or more promotional data structures 315 based upon minimum purchase quantities or minimum purchase amounts exceeding present purchase quantities or present purchase amounts defined by the one or more shopping cart interaction events 321 to the electronic shopping cart 322.

The one or more product notification data structures 323 can also comprise one or more negative recommendations 319. Illustrating by example, the negative recommendations 319 can question whether any consumable shopping cart interaction events can be consumed prior to expiration. The negative recommendations 319 can also suggest at least one alternate shopping cart addition for the consumable shopping cart interaction events as well. As described above, the negative recommendations 319 can also suggest at least one future promotional offer for the consumable shopping cart interaction events.

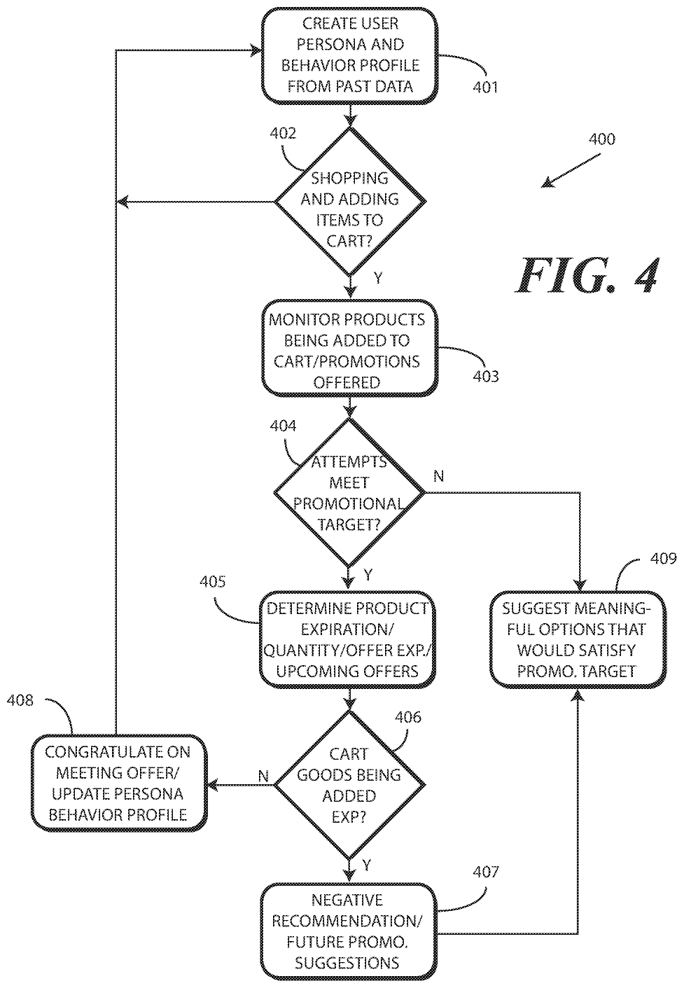

Turning now to FIG. 4, illustrated therein is another method 400 in accordance with one or more embodiments of the disclosure. Beginning at step 401, a user persona and behavior data structure is created as previously described. In one or more embodiments, the user persona and behavior data structure defines a frequency of past purchases made using an electronic shopping interactive computing environment. In one or more embodiments, the user persona and behavior data structure defines categories of past purchases made using the electronic shopping interactive computing environment, quantities of past purchases made using the electronic shopping interactive computing environment, one or more consumption trends associated with the past purchases made using the electronic shopping interactive computing environment, and other data. The user persona and behavior data structure can also define one or more expiration dates for at least some of the past purchases made using the electronic shopping interactive computing environment.

Decision 402 determines whether shopping cart interaction events add items to the electronic shopping cart of the electronic shopping interactive computing environment. Where they do, step 403 monitors both the items being added to the electronic shopping cart of the electronic shopping interactive computing environment and any promotional data structures, including any minimum purchase quantities and/or minimum purchase amounts associated with the promotional data structures.

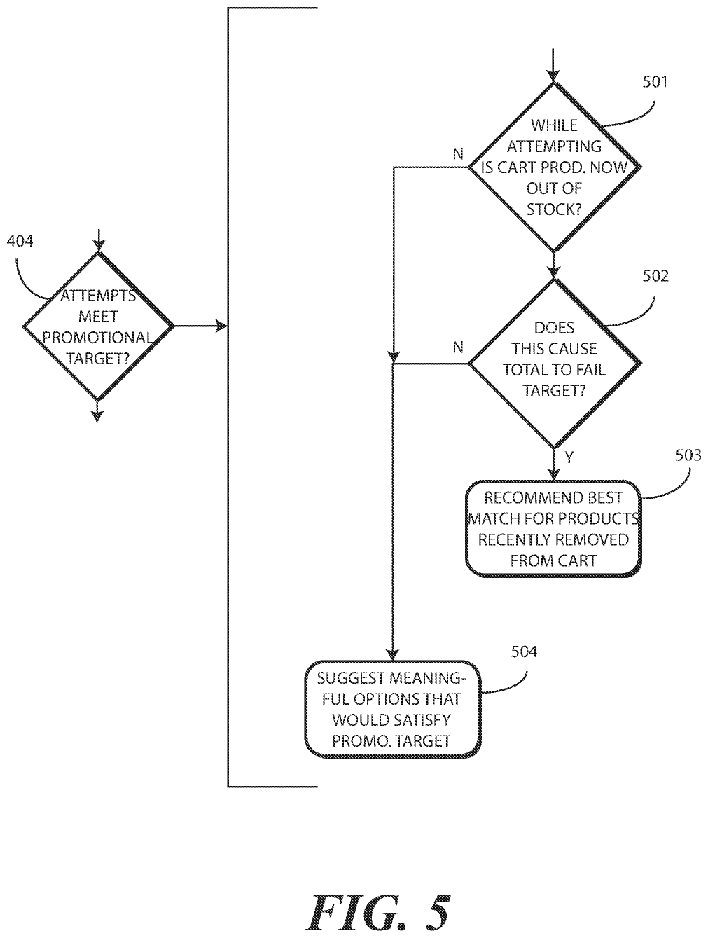

Decision 404 then determines whether the shopping cart interaction events are attempting to meet the promotional data structures monitored at step 403. In addition to determining whether the shopping cart interaction events meet the promotional data structures, decision 404 can include the determination of other information as well. Turning briefly now to FIG. 5, illustrates therein are some examples. Others will be obvious to those of ordinary skill in the art having the benefit of this disclosure.

In one or more embodiments, decision 404 further comprises determining, at step 501, whether any oscillations to the electronic shopping cart of the electronic shopping interactive computing environment resulted in any current electronic shopping cart items being out of stock. Decision 502 can then determine if the out of stock status causes the total shopping cart value to fall below the target of the promotional data structures. Where it does, a product notification data structures can be presented that includes a negative recommendation suggesting at least one alternate shopping cart addition for the out of stock item at step 503. Otherwise, step 504 can present one or more product notification data structures that include at least one notification offer meeting one or more promotional data structures based upon minimum purchase quantities or minimum purchase amounts exceeding present purchase quantities or present purchase amounts defined by the one or more shopping cart interaction events to the electronic shopping cart of the electronic shopping interactive computing environment at step 504.

Turning now back to FIG. 4, if there are not attempts to meet the one or more promotional data structures, as determined by decision 404, step 409 can comprise determining expiration dates of items in the electronic shopping cart of the electronic shopping interactive computing environment, quantity amounts compared to consumable quantities of the items in the electronic shopping cart of the electronic shopping interactive computing environment, and even future promotional offers. If decision 406 determines that consumable items in the electronic shopping cart of the electronic shopping interactive computing environment are likely to expire prior to being consumed, step 407 can comprise presenting a product notification data structure having a negative recommendation.

In one or more embodiments, the negative recommendation questions whether any consumable shopping cart items can be consumed prior to expiration. In other embodiments, the negative recommendation suggests at least one alternate shopping cart addition for at least one consumable shopping cart items. Where future promotional offers are detected at step 405, the negative recommendation presented at step 407 can comprise at least one future promotional offer for the consumable shopping cart items. Other examples of negative recommendations suitable for presentation at step 407 will be obvious to those of ordinary skill in the art having the benefit of this disclosure.

If decision 406 determines that the consumable electronic shopping cart items are unlikely to expire before consumption, step 408 can comprise presenting a congratulatory message on the user interface of an electronic device congratulating the user on meeting the one or more promotional data structures. Step 408 can also comprise updating the user persona and behavior data structure based upon the shopping cart interaction events detected throughout the method 400 as well. Other operations that can be performed at step 408 will be obvious to those of ordinary skill in the art having the benefit of this disclosure.

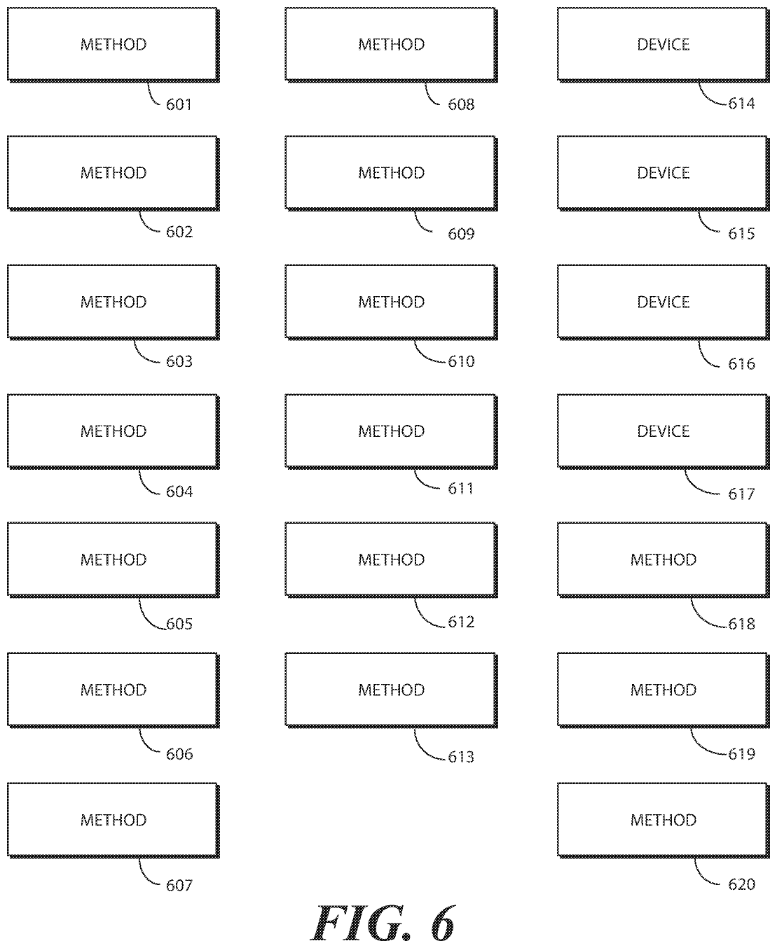

Turning now to FIG. 6, illustrated therein are various embodiments of the disclosure. The embodiments of FIG. 6 are shown as labeled boxes in FIG. 6 due to the fact that the individual components of these embodiments have been illustrated in detail in FIGS. 1-5, which precede FIG. 6. Accordingly, since these items have previously been illustrated and described, their repeated illustration is no longer essential for a proper understanding of these embodiments. Thus, the embodiments are shown as labeled boxes.

At 601, a method in an electronic device comprises, in response to initiation of an electronic shopping application portal operating on one or more processors of the electronic device, retrieving, by the one or more processors from a memory of the electronic device, a user persona and behavior profile defining one or more past purchase patterns occurring in the electronic shopping application portal or another electronic shopping application portal. At 601, the method comprises detecting, by the one or more processors from user input received by a user interface of the electronic device, shopping cart additions to an electronic shopping cart within the electronic shopping application portal.

At 601, the method comprises mapping, by the one or more processors, attempts within the electronic shopping application portal to meet one or more promotional offers based upon minimum purchase quantities and/or minimum purchase amounts. At 601, the method comprises causing, by the one or more processors, the user interface to present one or more processors product one or more notification offers meeting the one or more promotional offers as a function of the user persona and behavior profile.

At 602, the user persona and behavior data structure of 601 defines a frequency of past purchases made using the electronic shopping application portal or the other electronic shopping application portal. At 603, the user persona and behavior data structure of 602 defines categories of the past purchases made using the electronic shopping application portal or the other electronic shopping application portal.

At 604, the user persona and behavior data structure of 603 defines quantities of the past purchases made using the electronic shopping application portal or the other electronic shopping application portal. At 605, the user persona and behavior data structure of 604 defines one or more consumption trends associated with the past purchases made using the electronic shopping application portal or the other electronic shopping application portal. At 606, the user persona and behavior data structure of 605 defines one or more expiration dates for at least some of the past purchases made using the electronic shopping application portal or the other electronic shopping application portal.

At 607, the mapping of 606 determines a value of all of the shopping cart additions to the electronic shopping cart. At 608, the one or more notification offers of 607 meeting the one or more promotional offers identify products predicted to be consumed prior to expiration based upon the one or more consumption trends associated with the past purchases made using the electronic shopping application portal or the other electronic shopping application portal.

At 609, the mapping of 607 detects user input causing oscillation of the shopping cart additions to the electronic shopping cart attempting to meet the one or more promotional offers based upon the minimum purchase quantities and/or the minimum purchase amounts. At 610, the oscillation of 609 of the shopping cart additions results in consumable shopping cart additions predicted to be unconsumed prior to expiration based upon the one or more consumption trends associated with the past purchases made using the electronic shopping application portal or the other electronic shopping application portal, at least one notification offer of the one or more notification offers presented on the user interface comprises a negative recommendation.

At 611, the negative recommendation of 610 questions whether the consumable shopping cart additions can be consumed prior to expiration. At 612, the negative recommendation of 611 suggests at least one alternate shopping cart addition for the consumable shopping cart additions. At 613, the negative recommendation of 611 suggests at least one future promotional offer for the consumable shopping cart additions.

At 614, an electronic device comprises a user interface, a memory, and one or more processors operable with the user interface and the memory. At 614, in response to user input received by the user interface causing one or more shopping cart additions to an electronic shopping cart in an electronic shopping application operating on the one or more processors, the one or more processors cause the user interface to present at least one notification offer meeting one or more promotional offers based upon minimum purchase quantities or minimum purchase amounts exceeding present purchase quantities or present purchase amounts defined by the one or more shopping cart additions to the electronic shopping cart.

At 615, the one or more promotional offers of 614 comprise a free shipping offer contingent upon a minimum electronic shopping cart total. At 616, the one or more processors of 614 are configured to access a user persona and behavior profile recording past shopping cart additions made in the electronic shopping application, wherein the at least one notification offer comprises at least one pats shopping cart addition from the past shopping cart additions. At 617, the at least one offer of 616 optimizes consumption of a combination of the past shopping cart additions and the one or more shopping cart additions prior to expiration dates of the past shopping cart additions and the one or more shopping cart additions.

At 618, a method in an electronic device comprises creating, by one or more processors of the electronic device in a memory of the electronic device, a user persona and behavior profile defining one or more consumption patterns based upon frequencies of past purchases made, categories of the past purchases made, consumption trends of the past purchases made, quantities of the past purchases made, expiration dates of the past purchases made, and combinations thereof. At 618, the method comprises detecting, by the one or more processors from user input received by a user interface of the electronic device, shopping cart additions to an electronic shopping cart within an electronic shopping application portal operating on the one or more processors.

At 618, the method comprises defining, by the one or more processors in the memory, a map of a total shopping cart value of the shopping cart additions, one or more promotional offers of the electronic shopping application portal based upon minimum purchase quantities and/or minimum purchase amounts, and data from the user persona and behavior profile. At 618, the method comprises causing, by the one or more processors, a user interface to present indicia offering at least one additional shopping cart addition that facilitate achievement of the one or more promotional offers of the electronic shopping application portal based upon the minimum purchase quantities and/or the minimum purchase amounts.

At 619, the method of 618 further comprises detecting, by the one or more processors, user input causing oscillation of the shopping cart additions to the electronic shopping cart attempting to meet the one or more promotional offers based upon the minimum purchase quantities and/or the minimum purchase amounts. At 620, the method of 619 further comprises, when the oscillation of the shopping cart interaction events results in at least one shopping cart addition being unavailable to prevent the achievement of the one or more promotional data structures of the electronic shopping interactive computing environment based upon the minimum purchase quantities and/or the minimum purchase amounts, causing, by the one or more processors, the user interface to present other indica offering at least one other additional shopping cart addition related to the at least one shopping cart addition.

In the foregoing specification, specific embodiments of the present disclosure have been described. However, one of ordinary skill in the art appreciates that various modifications and changes can be made without departing from the scope of the present disclosure as set forth in the claims below. Thus, while preferred embodiments of the disclosure have been illustrated and described, it is clear that the disclosure is not so limited. Numerous modifications, changes, variations, substitutions, and equivalents will occur to those skilled in the art without departing from the spirit and scope of the present disclosure as defined by the following claims.

For example, in one or more embodiments a product notification data structures recommends specific items that would be useful, like consumable items, grocery items, and house cleaning items when the current electronic shopping cart total value is close to an available offer with those useful items having delayed expiration dates. When embodiments of the disclosure detect a user trying to add more items susceptible of not being consumed prior to expiration, the product notification data structures can alert the user to choose alternative products, and so forth.

Accordingly, the specification and figures are to be regarded in an illustrative rather than a restrictive sense, and all such modifications are intended to be included within the scope of present disclosure. The benefits, advantages, solutions to problems, and any element(s) that may cause any benefit, advantage, or solution to occur or become more pronounced are not to be construed as a critical, required, or essential features or elements of any or all the claims.

What is claimed is:

1. A method in an electronic device, the method comprising:
in response to initiation of an electronic shopping application portal operating on one or more processors of the electronic device, retrieving, by the one or more processors from a memory of the electronic device, a user persona and behavior profile defining one or more past purchase patterns occurring in the electronic shopping application portal or another electronic shopping application portal;
detecting, by the one or more processors from user input received by a user interface of the electronic device, shopping cart additions to an electronic shopping cart within the electronic shopping application portal;
mapping, by the one or more processors, attempts within the electronic shopping application portal to meet one or more promotional offers based upon minimum purchase quantities and/or minimum purchase amounts; and
causing, by the one or more processors, the user interface to present one or more processors product one or more notification offers meeting the one or more promotional offers as a function of the user persona and behavior profile.

2. The method of claim 1, wherein the user persona and behavior profile defines a frequency of past purchases made using the electronic shopping application portal or the another electronic shopping application portal.

3. The method of claim 2, wherein the user persona and behavior profile defines categories of the past purchases made using the electronic shopping application portal or the another electronic shopping application portal.

4. The method of claim 3, wherein the user persona and behavior profile defines quantities of the past purchases made using the electronic shopping application portal or the another electronic shopping application portal.

5. The method of claim 4, wherein the user persona and behavior profile defines one or more consumption trends associated with the past purchases made using the electronic shopping application portal or the another electronic shopping application portal.

6. The method of claim 5, wherein the user persona and behavior profile defines one or more expiration dates for at least some of the past purchases made using the electronic shopping application portal or the another electronic shopping application portal.

7. The method of claim 6, wherein the mapping determines a value of all of the shopping cart additions to the electronic shopping cart.

8. The method of claim 7, wherein the one or more notification offers meeting the one or more promotional offers identify products predicted to be consumed prior to expiration based upon the one or more consumption trends associated with the past purchases made using the electronic shopping application portal or the another electronic shopping application portal.

9. The method of claim 7, wherein the mapping detects user input causing oscillation of the shopping cart additions to the electronic shopping cart attempting to meet the one or more promotional offers based upon the minimum purchase quantities and/or the minimum purchase amounts.

10. The method of claim 9, wherein when the oscillation of the shopping cart additions results in consumable shopping cart additions predicted to be unconsumed prior to expiration based upon the one or more consumption trends associated with the past purchases made using the electronic shopping application portal or the another electronic shopping application portal, at least one notification offer of the one or more notification offers presented on the user interface comprises a negative recommendation.

11. The method of claim 10, wherein the negative recommendation questions whether the consumable shopping cart additions can be consumed prior to expiration.

12. The method of claim 11, wherein the negative recommendation suggests at least one alternate shopping cart addition for the consumable shopping cart additions.

13. The method of claim 11, wherein the negative recommendation suggests at least one future promotional offer for the consumable shopping cart additions.

14. An electronic device, comprising:
a user interface;
a memory; and
one or more processors operable with the user interface and the memory;
wherein, in response to user input received by the user interface causing one or more shopping cart additions to an electronic shopping cart in an electronic shopping application operating on the one or more processors, the one or more processors cause the user interface to present at least one notification offer meeting one or more promotional offers based upon minimum purchase quantities or minimum purchase amounts exceeding present purchase quantities or present purchase amounts defined by the one or more shopping cart additions to the electronic shopping cart.

15. The electronic device of claim 14, wherein the one or more promotional offers comprise a free shipping offer contingent upon a minimum electronic shopping cart total.

16. The electronic device of claim 14, wherein the one or more processors are configured to access a user persona and behavior profile recording past shopping cart additions made in the electronic shopping application, wherein the at least one notification offer comprises at least one past shopping cart addition from the past shopping cart additions.

17. The electronic device of claim 16, wherein the at least one offer optimizes consumption of a combination of the past shopping cart additions and the one or more shopping cart additions prior to expiration dates of the past shopping cart additions and the one or more shopping cart additions.

18. A method in an electronic device, the method comprising:
creating, by one or more processors of the electronic device in a memory of the electronic device, a user persona and behavior profile defining one or more consumption patterns based upon:
frequencies of past purchases made;
categories of the past purchases made;
consumption trends of the past purchases made;
quantities of the past purchases made;
expiration dates of the past purchases made; and
combinations thereof;
detecting, by the one or more processors from user input received by a user interface of the electronic device, shopping cart additions to an electronic shopping cart within an electronic shopping application portal operating on the one or more processors;
defining, by the one or more processors in the memory, a map of:
a total shopping cart value of the shopping cart additions;
one or more promotional offers of the electronic shopping application portal based upon minimum purchase quantities and/or minimum purchase amounts; and
data from the user persona and behavior profile; and
causing, by the one or more processors, a user interface to present indicia offering at least one additional shopping cart addition that facilitate achievement of the one or more promotional offers of the electronic shopping application portal based upon the minimum purchase quantities and/or the minimum purchase amounts.

19. The method of claim 18, further comprising detecting, by the one or more processors, user input causing oscillation of the shopping cart additions to the electronic shopping cart attempting to meet the one or more promotional offers based upon the minimum purchase quantities and/or the minimum purchase amounts.

20. The method of claim 19, further comprising, when the oscillation of the shopping cart interaction events results in at least one shopping cart addition being unavailable to prevent the achievement of the one or more promotional offers of the electronic shopping application portal based upon the minimum purchase quantities and/or the minimum purchase amounts, causing, by the one or more processors, the user interface to present other indica offering at least one other additional shopping cart addition related to the at least one shopping cart addition.
